(19) United States
(12) Patent Application Publication
(10) Pub. No.: US 2010/0228563 A1
(43) Pub. Date: Sep. 9, 2010

(54) SYSTEM AND METHOD FOR PREVENTING HEALTH CARE FRAUD

(76) Inventors: Samuel E. Walker, JR., Hanover, MD (US); Diallo I. Bennett, Washington, DC (US)

Correspondence Address: PCT LAW GROUP, PLLC, 818 CONNECTICUT AVENUE, NW, SUITE 700, WASHINGTON, DC, 20006, US

(21) Appl. No.: 12/719,563

(22) Filed: Mar. 8, 2010

Related U.S. Application Data
(60) Provisional application No. 61/158,385, filed on Mar. 8, 2009.

(51) Int. Cl. G06Q 50/00; G06Q 40/00; G06Q 10/00

(52) U.S. Cl. 705/2

(57) ABSTRACT

Systems, methods and computer program products for discouraging and preventing health care-related insurance fraud are disclosed. In an aspect, an insured (e.g., Medicaid) beneficiary identity validation eligibility verification tool is provided that identifies Medicaid beneficiaries using biometrics and verifies their Medicaid eligibility electronically each time they visit a health care provider who participates in the Medicaid program. In such an aspect, an electronic encounter record is created between the provider and the validated and verified beneficiary each time health care services are rendered. The tool of the present invention thus enables insurance companies, regulatory bodies and the like to match submitted claims to captured encounter records as proof that the beneficiary did visit the provider in question on the reported date of service.

### CROSS-REFERENCE TO RELATED APPLICATIONS

This Application claims the benefit of, and is related to, Applicants' co-pending U.S. Provisional Patent Application No. 61/158,385 titled “System and Method for Preventing Health Care Fraud,” filed on Mar. 8, 2009, which is incorporated by reference herein in its entirety.

### BACKGROUND OF THE INVENTION

1. Field of the Invention

The present invention generally relates to systems and method for preventing fraud, and, more specifically, to systems, methods and computer program products for discouraging and preventing health care-related insurance fraud.

2. Related Art

Health care fraud is the intentional deception or misrepresentation that an individual or entity makes knowing that the misrepresentation could result in some unauthorized benefit to the individual, the entity, or to some other party. Such benefit is often paid by a private insurance company or a public (i.e., state or federal) insurance program.

The most common kind of health care-related fraud involves a false statement, misrepresentation or deliberate omission that is critical to the determination of the amount of benefits payable. Fraudulent activities are almost invariably criminal, although the specific nature or degree of the criminal acts may vary from jurisdiction to jurisdiction. The variety of fraudulent reimbursement and billing practices in the health care area is potentially infinite. The most common fraudulent acts include: (1) billing for services, procedures and/or supplies that were never provided or performed; (2) the deliberate performance of medically unnecessary services for the purpose of financial gain; or (3) intentionally misrepresenting any of the following, for purposes of obtaining a payment—or a greater payment—to which one is not entitled:
The nature of services, procedures and/or supplies provided or performed;
The dates on which services and/or treatments were rendered;
The medical record of service and/or treatment provided;
The condition treated or the diagnosis made;
The charges for services, procedures and/or supplies provided or performed; or
The identity of the provider or the recipient of services, procedures and/or supplies.

Fraud continues to persist because, in 2007 for example, the United States spent more than $2.26 trillion on health care. Of that amount, The National Health Care Anti-Fraud Association (NHCAA)—a leading private-public partnership national organization—estimates conservatively that at least three percent (i.e., more than $68 billion) is lost to health care fraud. That amount is more than the gross domestic product (GDP) of 120 different countries. This enormous loss directly impacts patients, taxpayers and government through higher heath care costs, insurance premiums and taxes. Additionally, health care fraud often hurts patients who may be subjected to unnecessary or unsafe procedures or who may be the victims of identity theft.

Given the foregoing, what are needed are systems, methods and computer program products for discouraging and preventing health care-related insurance fraud in ways superior to prior proposed solutions such as those described in, for example, U.S. Pat. Nos. 7,421,399 and 7,209,886, to Kimmel, which are each hereby incorporated by reference in their entirety.

### SUMMARY OF THE INVENTION

The present invention meets the above-identified needs by providing systems, methods and computer program products for discouraging and preventing health care-related insurance fraud.

In one aspect, an insured (e.g., Medicaid) beneficiary identity validation and eligibility verification tool is provided that identifies Medicaid beneficiaries using biometrics and verifies their Medicaid eligibility electronically each time they visit a health care provider who participates in the Medicaid program. In such an aspect, the tool of the present invention is a web application executing on one or more web servers and accessible by a plurality of health care system participants (i.e., patients, providers, insurance administrators and the like) at various locations via various terminals. Further, in such an aspect, an electronic encounter record is created between the provider and the validated and verified beneficiary each time health care services are rendered. The tool of the present invention thus enables insurance companies, regulatory bodies and the like to match submitted claims to captured encounter records as proof that the beneficiary did visit the provider in question on the reported date of service.

In an aspect, the present invention provides a method for preventing health care fraud that includes the steps of storing, in a central repository, a first biometric signature received from an insurance recipient during an enrollment period. Next, a first set of demographic information (i.e., social security number, photograph, insurance or Medicaid identification number, date of birth, name, address, Medicaid eligibility and the like) is received from the insurance recipient during the enrollment period and associating the first set of demographic information with the first biometric signature. Then, during a visit to a health care provider, a second biometric signature and a second set of demographic information is received from a patient. This is followed by the retrieval of the first biometric signature and the first set of demographic information from the central repository. The first and second sets of data are compared to verify the identity and insurance eligibility of the patient as the insurance recipient. This allows an encounter record to be created in the central repository, wherein the encounter records comprises a flag indicating the results of the comparisons.

An advantage of the present invention is that it allows beneficiary identity to be established when the beneficiary is deemed insurance (e.g., Medicaid) eligible at an enrollment office; whereas prior art systems attempted to establish beneficiary identity when the patient visits a health care provider for the first time, where a patient's identity cannot typically be officially confirmed.

Another advantage of the present invention is that when a beneficiary visits a health care provider, they “check-in” by scanning in their biometric signature which then can be sent to a central repository not only to be verified, but to also provide the health care provider's office with previously-stored (i.e., during enrollment) beneficiary demographic information (i.e., social security number, photograph, insurance or Medicaid identification number, date of birth, name, address, Medicaid eligibility and the like).

Yet another advantage of the present invention is that it can be integrated with an insurance company or state Medicaid payment system. That is, when a medical claim is made to an insurance agency or state for payment, the respective claims system can make a request to the present invention's centralized server to verify that an encounter record exist for the provider/beneficiary interaction noted on the medical claim, thereby allowing a search of the associated central repository in order to respond with a “Yes” or “No” verification.

Further features and advantages of the present invention, as well as the structure and operation of various aspects of the present invention, are described in detail below.

### BRIEF DESCRIPTION OF THE DRAWINGS

Various aspects and other aspects of this invention will be readily apparent from the detailed description below and the appended drawings, which are meant to illustrate and not to limit the invention, and in which:

FIGS. 1-4 are block/dataflow diagrams of an exemplary beneficiary identity validation and eligibility verification system according to various aspects of the invention; and

FIG. 5 is a block diagram of an exemplary computer system useful for implementing the present invention.

### DETAILED DESCRIPTION

The present invention is directed to systems, methods and computer program products for discouraging and preventing health care-related insurance fraud.

In an aspect of the present invention, a Medicaid beneficiary identity validation and eligibility verification tool is provided that identifies beneficiaries using biometrics and verifies their eligibility each time they visit a health care provider. The present invention is now described in more detail herein in terms of this context. This is for convenience only and is not intended to limit the application of the present invention. In fact, after reading the following description, it will be apparent to those skilled in the relevant art(s) how to implement the following invention in alternative aspects (e.g., in the context of a private insurer, a different public insurance program, and the like).

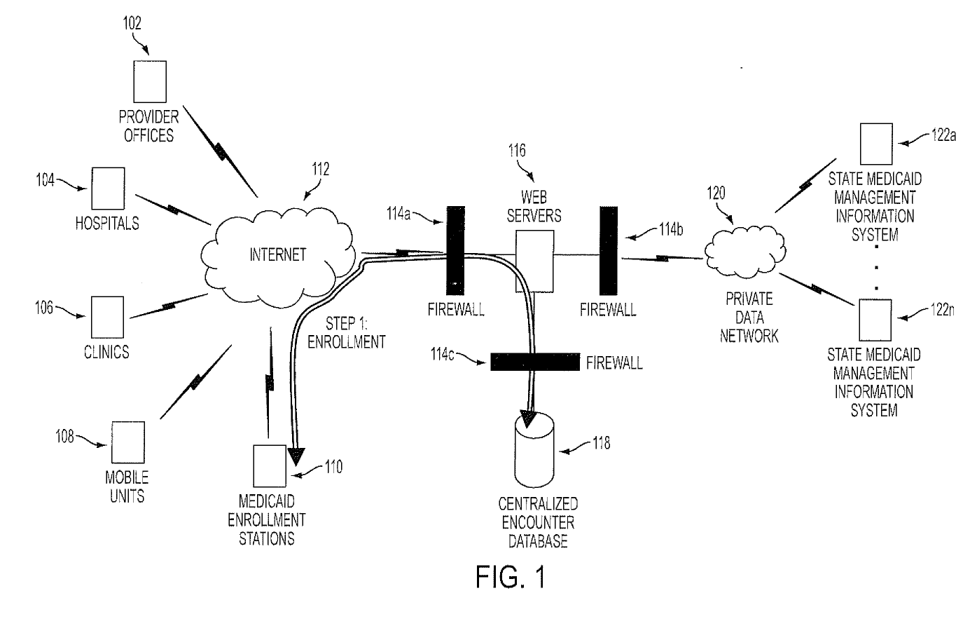

Referring to FIG. 1, a block diagram of an exemplary beneficiary identity validation and eligibility verification system and enrollment process, according to an aspect of the invention, is shown. In such an aspect, the following enrollment process may occur:
1. A recipient visits a state Medicaid office, deemed Medicaid eligible, and is provided with a valid Medicaid ID;
2. The personal information of the newly-recognized Medicaid recipient (e.g., Social Security Number (SSN), Medicaid ID, date of birth, name, address and the like) is keyed into a web application executing at least partially on a web server 116 via a medical enrollment station 110;
3. The Medicaid recipient provides biometric signature to the web application;
4. The Medicaid recipient's photograph is taken and submitted to the web application; and
5. All of the information/data referenced above is transferred via a network (e.g., global, public Internet 112), and stored in a central database repository 118.

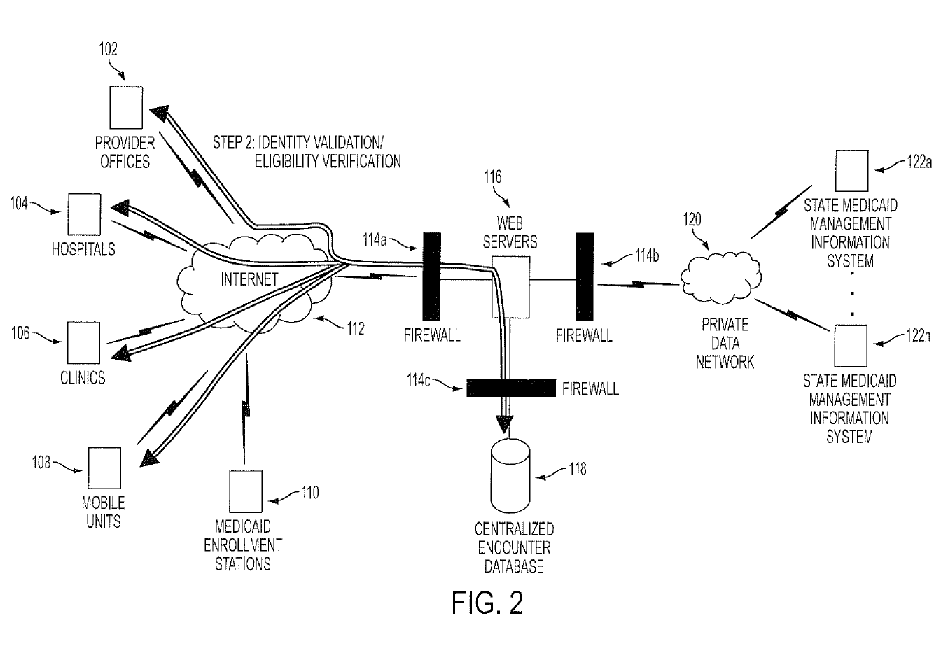

Referring to FIG. 2, a block diagram of an exemplary beneficiary identity validation and eligibility verification system and identity validation/eligibility verification process, according to an aspect of the invention, is shown. In such an aspect, the following identity validation/eligibility verification process may occur:
1. The Medicaid recipient goes to a provider's location (i.e., a medical provider's office 102, hospital 104, clinic 106 or mobile unit 108) where an intake coordinator is logged into the web application; the Medicaid recipient then provides his/her Medicaid ID, SSN, date of birth, and biometric signature to the web application;
2. The collected information is inputted into the web application and transmitted over a network (e.g., the Internet 112) to central database repository 118; the web application then performs a search using the recipient information in order to find a unique match within database 118;
3. If a match is found within database 118, then the web application returns information (via one of terminals 102-108) pertaining to the recipient such as their demographics, Medicaid eligibility and photograph;
4. If a match is not found, then a message is returned to the intake coordinator (via one of terminals 102-108) stating that the recipient is not present in database 118; and
5. If a match is found, but a different biometric signature is associated within database 118, the event is logged and the web application returns a message to the intake coordinator stating that a biometric mismatch has occurred.

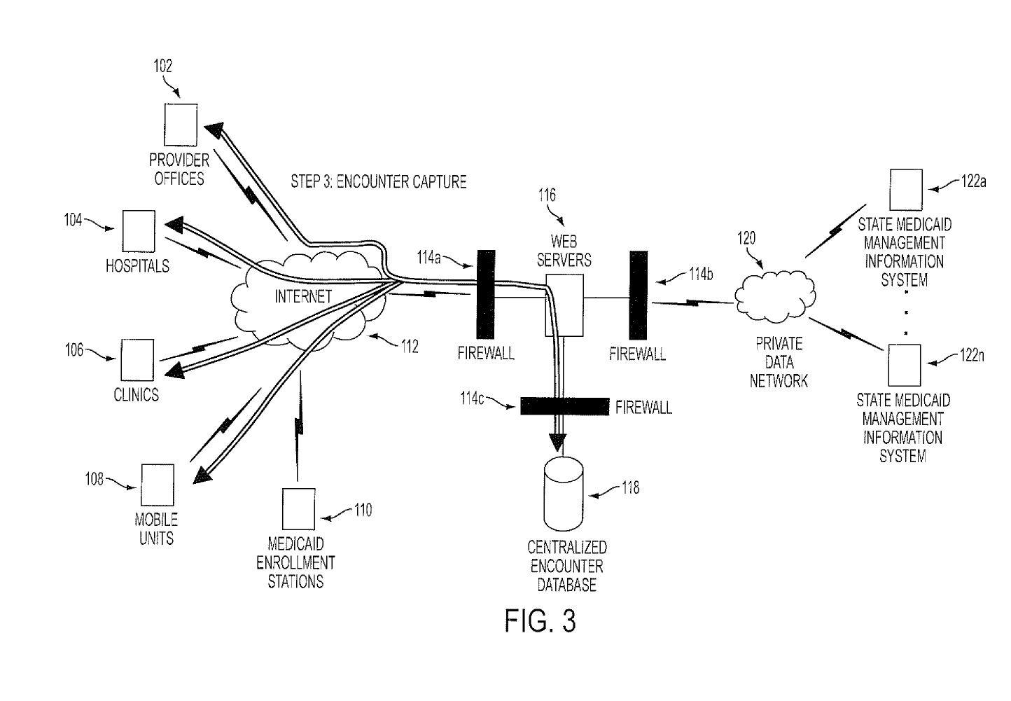

Referring to FIG. 3, a block diagram of an exemplary beneficiary identity validation and eligibility verification system and encounter capture process, according to an aspect of the invention, is shown. In such an aspect, the following encounter capture process may occur:
1. If a match is found in database 118 during the validation/eligibility verification process described in connection with FIG. 2 using Medicaid ID, SSN, DOB and biometric signature, an encounter record is created in central database repository 118 denoting that the recipient (with unique recipient ID) visited the provider (with specific provider ID) on a particular date; and
2. If a match is found in database 118 during the validation/eligibility verification process described in connection with FIG. 2 using Medicaid ID, SSN and DOB, but the biometric ID is different, then an encounter record is created in central database repository 118 denoting that the recipient (with unique recipient ID) visited the provider (with specific provider ID) on a particular date. A flag, however, is also set within the record which denotes that the identity of the recipient was not verified.

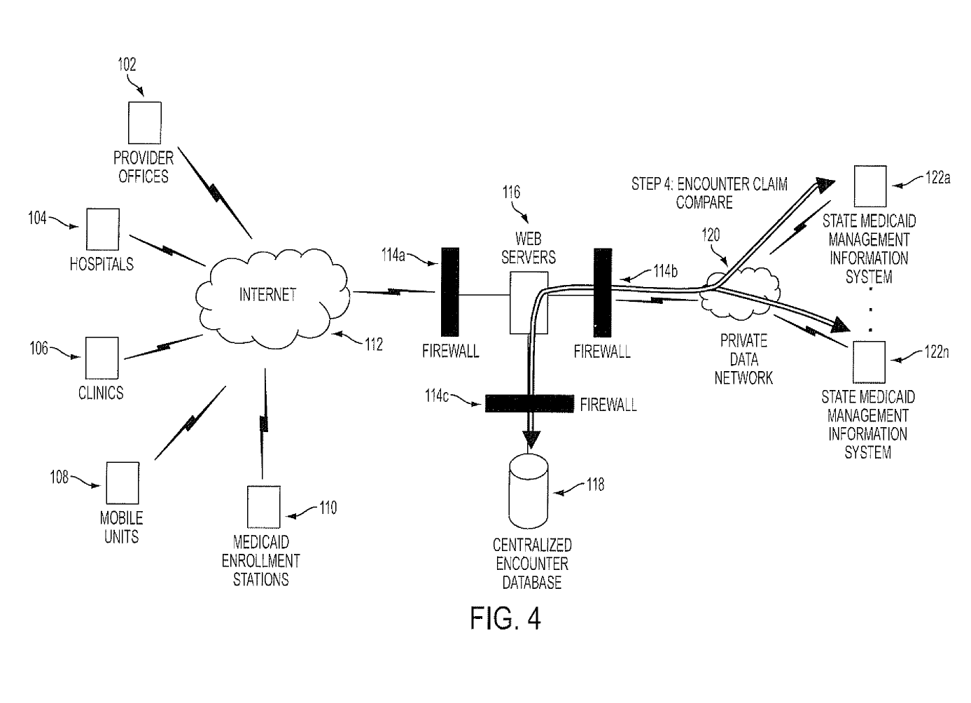

Referring to FIG. 4, a block diagram of an exemplary beneficiary identity validation and eligibility verification system and encounter claim compare process, according to an aspect of the invention, is shown. In such an aspect, the following encounter claim compare process may occur:
1. A state's Medicaid claims processing system (shown as state Medicaid Management Information System 122a-n in FIG. 4) creates an extract file of claims which consists of records that contain the unique claim number, provider ID, recipient ID, and dates of service;
2. The extract file is transmitted to central database repository 118 where, in one aspect, the connection between a state's system 122 and central database repository 118 is a “private” point-to-point telecommunications connection via a private data network 120;
3. The web application creates a copy of the extract file that will be transmitted back to the state's Medicaid claims processing system 122 consisting of the unique claim number, provider ID, recipient ID, and flag information;
4. For each record in the original extract file, the web application searches central database repository 118 for a matching encounter record;
5. If a matching encounter record is found, the web application modifies the corresponding flag information for the specific record to be “yes”;
6. If a matching encounter record is not found, the web application modifies the corresponding flag information for the specific record to be “no”;
7. Each record in the extract file is checked for a matching encounter record until all of the records have been checked; and
8. Once complete, the web application sends the file containing the flag information back to the state's Medicaid claims processing system 122 using the point-to-point telecommunications connection via a private data network 120.

As will be appreciated by those skilled in the relevant art(s) after reading the description herein, in an aspect, the web application described above executes on one or more web servers 116 (as shown in FIGS. 1-4) providing one or more websites which send out web pages in response to Hypertext Transfer Protocol (HTTP) or Hypertext Transfer Protocol Secured (HTTPS) requests from remote browsers. Thus, such web servers 116 are able to provide a graphical user interface (GUI) to users of the beneficiary identity validation and eligibility verification system in the form of web pages. These web pages are sent to user's desktop, laptop, mobile device, PDA or like terminal devices (at locations 102-110 and 122), and result in the GUI screens being displayed.

As will also be appreciated by those skilled in the relevant art(s) after reading the description herein, in an aspect, the traffic between the web application's executing on web server 116 and all other components of the beneficiary identity validation and eligibility verification system shown in FIGS. 1-4 is routed through one or more firewalls (shown as firewalls 114a-c) configured such that only authorized connections can gain access to the system's data. The purpose of the firewall is to provide security and restrict unauthorized access to the system and the patient data stored and processed therein.

As will also be appreciated by those skilled in the relevant art(s) after reading the description herein, in an aspect, an application service provider (i.e., an entity providing the infrastructure for one or more health care providers, insurers and/or recipients) with multiple locations at one or more corresponding URLs) may allow access, on a paid subscriber/membership, and/or pay-per-use basis, to the tools (i.e., web application) the present invention provides for performing beneficiary identity validation and eligibility verification.

### Exemplary Implementation

The present invention (i.e., the process steps described above with reference to FIGS. 1-4, and the systems and methods for discouraging and preventing health care-related insurance fraud described above, or any part(s) or function(s) thereof) may be implemented using hardware, software or a combination thereof and may be implemented in one or more computer systems or other processing systems. However, the manipulations performed by the present invention were often referred to in terms, such as “selecting” or “documenting,” which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

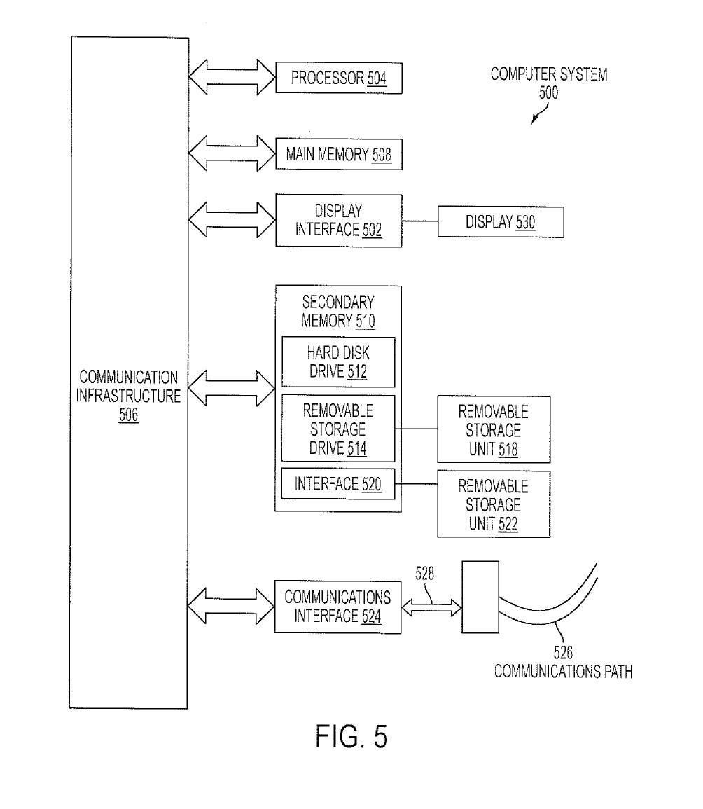

In fact, in one aspect, the invention is directed toward one or more computer systems capable of carrying out the functionality described herein. An example of a computer system 500 is shown in FIG. 5.

Computer system 500 includes one or more processors, such as processor 504. The processor 504 is connected to a communication infrastructure 506 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on the display unit 530.

Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518 represents a floppy disk, magnetic tape, optical disk, etc. which is read by and written to by removable storage drive 514. As will be appreciated, the removable storage unit 518 includes a computer usable storage medium having stored therein computer software and/or data.

In alternative aspects, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modern, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 514, a hard disk installed in hard disk drive 512, and signals 528. These computer program products provide software to computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an aspect where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

In general, computer-readable memory media applied in association with aspects of the invention described herein may include any memory medium capable of storing instructions executed by a programmable apparatus. Where applicable, method steps described herein may be embodied or executed as instructions stored on a computer-readable memory medium or memory media. These instructions may be software embodied in various programming languages such as C++, C, Java, PHP, and/or a variety of other kinds of software programming/scripting languages that may be applied to create instructions in accordance with aspects of the invention.

### CONCLUSION

It is to be understood that the figures and descriptions of the invention have been simplified to illustrate elements that are relevant for a clear understanding of the invention, while eliminating, for purposes of clarity, other elements. Those of ordinary skill in the art will recognize, however, that these and other elements may be desirable. However, because such elements are well known in the art, and because they do not facilitate a better understanding of the invention, a discussion of such elements is not provided herein. It should be appreciated that the figures are presented for illustrative purposes and not as construction drawings. Omitted details and modifications or alternative aspects are within the purview of persons of ordinary skill in the art.

It can be appreciated that, in certain aspects of the invention, a single component may be replaced by multiple components, and multiple components may be replaced by a single component, to provide an element or structure or to perform a given function or functions. Except where such substitution would not be operative to practice certain aspects of the invention, such substitution is considered within the scope of the invention.

Variations, modifications, and other implementations of what is described herein will occur to those of ordinary skill in the relevant art(s) without departing from the spirit and scope of the invention.

The examples presented herein are intended to illustrate potential and specific implementations of the invention. It can be appreciated that the examples are intended primarily for purposes of illustration of the invention for those skilled in the relevant art(s). There may be variations to these diagrams or the operations described herein without departing from the spirit of the invention. For instance, in certain cases, method steps or operations may be performed or executed in differing order, or operations may be added, deleted or modified.

Furthermore, whereas particular aspects of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described herein.

Further, the purpose of the foregoing Abstract is to enable the U.S. Patent and Trademark Office and the public generally, and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A method for preventing health care fraud, comprising the steps of:
(a) storing, in a central repository, a first biometric signature received from an insurance recipient during an enrollment period;
(b) storing, in said central repository, a first set of demographic information received from said insurance recipient during said enrollment period and associating said first set of demographic information with said first biometric signature;
(c) receiving, during a visit to a health care provider, a second biometric signature and a second set of demographic information from a patient, wherein said visit to said health care provider occurs after said enrollment period;
(d) retrieving said first biometric signature and said first set of demographic information from said central repository;
(e) comparing said first biometric signature to said second biometric signature, and comparing at least a portion of said first set demographic information to at least a portion of said second set of demographic information; and
(f) creating an encounter record in said central repository, wherein said encounter records comprises a flag indicating the results the comparisons made in step (e);
whereas the identity of said patient as said insurance recipient and eligibility to receive health care from said health care provider may be verified prior to an insurance claim related to said visit is processed.

2. The method of claim 1, wherein said first set of demographic information comprises at least one of the following: social security number; photograph; insurance identification number; date of birth; name; and address.

3. The method of claim 2, wherein said encounter record comprises: a first unique identification number associated with said patient; a second unique identification number associated with said provider; the date of said visit; and a unique claim number.

4. The method of claim 3, further comprising the steps of:
(g) receiving an extract file at said central repository, wherein said extract file contains a plurality of records, each associated with an insurance claim;
(h) determining, using at least said unique claim number, when said encounter record matches one of said plurality of records in said extract file; and
(i) modifying said one of said plurality of records in said extract file based on the determination of step (h).

5. The method of claim 4, wherein said each of said plurality of records in said extract file comprises a flag which is set to one of “yes” and “no” based upon the determination of step (h).

6. The method of claim 5, further comprising the step of transmitting said extract file to an insurance provider who insures said insurance recipient.

7. A computer program product comprising a computer usable medium having control logic stored therein for causing a computer to facilitate the prevention of health care fraud, said control logic comprising:
first computer readable program code means for causing the computer to store, in a central repository, a first biometric signature received from an insurance recipient during an enrollment period;
second computer readable program code means for causing the computer to store, in said central repository, a first set of demographic information received from said insurance recipient during said enrollment period and associating said first set of demographic information with said first biometric signature;
third computer readable program code means for causing the computer to receive, during a visit to a health care provider, a second biometric signature and a second set of demographic information from a patient, wherein said visit to said health care provider occurs after said enrollment period;
fourth computer readable program code means for causing the computer to retrieve said first biometric signature and said first set of demographic information from said central repository;
fifth computer readable program code means for causing the computer to compare said first biometric signature to said second biometric signature, and compare at least a portion of said first set demographic information to at least a portion of said second set of demographic information; and
sixth computer readable program code means for causing the computer to create an encounter record in said central repository;
whereas the identity of said patient as said insurance recipient and eligibility to receive health care from said health care provider may be verified prior to an insurance claim related to said visit is processed.

8. The computer program product of claim 7, wherein said first set of demographic information comprises at least one of the following: social security number; photograph; insurance identification number; date of birth; name; and address.

9. The computer program product of claim 8, wherein said encounter record comprises: a first unique identification number associated with said patient; a second unique identification number associated with said provider; the date of said visit; and a unique claim number.

10. The computer program product of claim 9, further comprising:
seventh computer readable program code means for causing the computer to receive an extract file at said central repository, wherein said extract file contains a plurality of records, each associated with an insurance claim;
eighth computer readable program code means for causing the computer to determine, using at least said unique claim number, when said encounter record matches one of said plurality of records in said extract file; and
ninth computer readable program code means for causing the computer to modify said one of said plurality of records in said extract file based on the determination of said eighth computer readable program code means.

11. The computer program product of claim 10, wherein said each of said plurality of records in said extract file comprises a flag which is set to one of “yes” and “no” based upon the determination of said eighth computer readable program code means.

12. The computer program product of claim 11, further comprising:
tenth computer readable program code means for causing the computer to transmit said extract file to an insurance provider who insures said insurance recipient.

13. A system for preventing health care fraud, comprising:
(a) at least one central repository capable of storing:
a first biometric signature received from an insurance recipient during an enrollment period; and
a first set of demographic information received from said insurance recipient during said enrollment period and associating said first set of demographic information with said first biometric signature;
and
(b) at least one web server, coupled to said at least one central repository, configured to:
receive, during a visit to a health care provider, a second biometric signature and a second set of demographic information from a patient, wherein said visit to said health care provider occurs after said enrollment period;
retrieve said first biometric signature and said first set of demographic information from said at least one central repository;
compare said first biometric signature to said second biometric signature;
compare at least a portion of said first set demographic information to at least a portion of said second set of demographic information; and
create an encounter record in said at least one central repository, wherein said encounter records comprises a flag indicating the results the comparisons made by said at least one web server;
whereas the identity of said patient as said insurance recipient and eligibility to receive health care from said health care provider may be verified prior to an insurance claim related to said visit is processed.

14. The system of claim 13, wherein said first set of demographic information comprises at least one of the following: social security number; photograph; insurance identification number; date of birth; name; and address.

15. The system of claim 14, wherein said encounter record comprises: a first unique identification number associated with said patient; a second unique identification number associated with said provider; the date of said visit; and a unique claim number.

16. The system of claim 15, wherein said at least one web server is further configured to:
receive an extract file that contains a plurality of records, each associated with an insurance claim;
determine, using at least said unique claim number, when said encounter record matches one of said plurality of records in said extract file; and
modify said one of said plurality of records in said extract file.

17. The system of claim 16, wherein said each of said plurality of records in said extract file comprises a flag which is set to one of “yes” and “no”.

18. The system of claim 17, wherein said at least one web server is further configured to transmit said extract file to an insurance provider who insures said insurance recipient.
